(19) United States
(12) Patent Application Publication
(10) Pub. No.: US 2002/0117902 A1
(43) Pub. Date: Aug. 29, 2002

(54) Remote safety switch for electric appliances

(76) Inventors: Michael F. Evers, Hoboken, NJ (US); Mark Raffel, Port Washington, WI (US); Lee B. Raffel, Port Washington, WI (US)

Correspondence Address: Ronald R. Santucci, Pitney, Hardin, Kipp & Szuch, LLP, 20th Floor, 711 Third Avenue, New York, NY, 10017, US

(21) Appl. No.: 09/792,775

(22) Filed: Feb. 23, 2001

(51) Int. Cl. H02J 3/00

(52) U.S. Cl. 307/130

(57) ABSTRACT

A power control device including a remote switch box having a remote switch box having a remote safety switch and a micro-controller, and an interface box operably controlled by the micro-controller. When operated, the remote safety switch prevents unauthorized use of electrical appliances as well as: continued shutdown of electrical appliances after a power outage; regulation of power input for electrical appliances; and detached remote operation.

### BACKGROUND OF THE INVENTION

1. Field of the Invention

This invention relates to a remote safety switch for an electrical appliance, and more particularly to a power control device including a remote switch box having a remote safety switch and a micro-controller, and an interface box operably controlled by the micro-controller. When operated the remote safety switch prevents unauthorized use of electrical appliances as well as: continued shutdown of electrical appliances after a power outage; regulation of power input for electrical appliances; and detached remote operation.

2. Description of the Prior Art

In any workplace or home, there can be any number of electric appliances in use at anytime. Most appliances have easily accessible control features which can energize or de-energize the appliance. Without knowing or disregarding the consequences of their actions, an unauthorized user may activate or de-activate an electrical appliance. Left unattended or used improperly, an electrical appliance can cause fire, loss of property, injury, or loss of life. Also, if there is a power outage, some appliances that were deactivated will be reactivated after the power outage ceases. Depending on the length of the outage, the appliance may be left unattended when reactivated. In this circumstance, an unattended electrical appliance can also cause fire, loss of property, injury, or loss of life.

A number of attempts have been made to secure unauthorized use of electrical appliances or to regulate power to electrical appliances by use of a control mechanism of different types. In Keiezer et al. patents (U.S. Pat. Nos. 5,734,206; 5,486,725; and 5,592,032) disclose a security power interrupt apparatus that prevents unauthorized use of an electric stove. The device includes a relay controlled by a microprocessor based on a programmable controller. The software includes a timer interrupt resulting in a relay disconnecting the power supply from the device when a preset timer has elapsed unless an authorized user reenters an unlocking sequence (e.g. a password)into the controller. The software also disconnects the controller when certain events occur (e.g. a smoke detector is triggered by smoke, a photo sensor is triggered by an open flame, a motion sensor does not measure movement within a period of time, etc.) When an interrupt occurs, the relay remains inactive until an authorized user enters an unlocking sequence into the controller.

Knutson (U.S. Pat. No. 4,659,909) discloses a kitchen range safety shut-off switch. The switch includes a smoke detector mounted externally, but adjacent to an electric range. The smoke detector supplies a signal interrupting the power supplied to the range. Upon activation, the interrupt requires a manual reset before the supply of power to the range is resumed.

Bethea (U.S. Pat. No. 4,755,691) discloses a receptacle housing connected to two remote switch boxes. A circuit is disclosed having a step down transformer, four switches, and two relays. Depending on the location of the four switches, a current is allowed to flow from the step-down transformer to the control windings of the relays.

Holdgaard-Johnson (U.S. Pat. No. 4,782,420) discloses an automatic safety switch apparatus for interrupting power due an electrical appliance. The interrupt occurs after a predetermined period of time elapses.

Coela et al. (U.S. Pat. No. 5,742,464) discloses an electric device capable of interrupting electrical power to an electrical appliance. The device interrupts electrical power in response to an increase in temperature of either the power cord plug of the electric appliance or the terminals of the power source pass a set point temperature. The interrupt ceases once the temperature decreases below a set point.

It is seen from the foregoing that there is a need for a remote switching device for an electrical appliance operable to interrupt power flow to an electric appliance upon a power failure and to continue preventing electric power from being provided to the electric appliance after the power failure ceases. It is also seen from the foregoing that there is a need for a remote safety switch of the type above which can only be reset by authorized users, in order to restore power to the electrical appliances.

### SUMMARY OF THE INVENTION

It is therefore an object of the present invention to provide a remote safety switch operable to interrupt power flow to an electric appliance upon power failure and continuing to prevent electric power from being provided to the electric appliance after the power failure ceases.

It is therefore a further object of the present invention to provide a remote safety switch which prevents unauthorized use of electrical appliances.

It is therefore a still further object of the present invention to provide a remote safety switch that is activated and de-activated by a key-operated switch that may be mounted at any convenient location for safety and security reasons.

It is therefore a still further object of the present invention to provide a remote safety switch that is activated and deactivated by a micro-controller that may be mounted at any convenient location for safety and security reasons.

It is therefore a still further object of the present invention to provide a remote safety switch that is activated and deactivated by a detached coded remote control instrument.

It is therefore a still further object of the present invention to provide a remote safety switch which permits higher electric power flow during specific periods.

It is therefore a still further object of the present invention to provide a remote safety switch which allows continuous low current to an electrical appliance but would restrict power flow if over-current exists and would then require the reset of the remote safety switch by an authorized user.

It is therefore a still further object of the present invention to provide a remote safety switch which would automatically restrict electric power flow to an electrical appliance after a certain amount of time elapses.

It is therefore a still further object of the present invention to provide a remote safety switch which would automatically supply low voltage to an electrical appliance after a certain amount of time elapses.

It is therefore a still further object of the present invention to provide a remote safety switch with an indicator LED to allow the user to see an on/off condition.

It is therefore a still further object of the present invention to provide a remote safety switch which can be simply installed with most electrical appliances.

It is therefore a still further object of the present invention to provide a remote safety switch which is convenient to use.

To attain the objects described, there is provided a device which is a remote safety switch for electrical appliances. The remote safety switch is a power control device comprising a remote switch box having a remote safety switch and a micro-controller, and an interface box operably controlled by the micro-controller. The interface box is in electrical communication between a wall receptacle and an electrical appliance.

During operation, when a mechanical switch of the remote safety switch is open, the micro-controller provides a signal to the interface box preventing electrical power from flowing through the interface box to an electric appliance. When the mechanical switch of the remote safety switch is closed, the micro-controller provides a signal to the interface box allowing electrical power to flow through the interface box to the electric appliance.

During a power failure, the micro-controller provides a signal to the interface box preventing electrical power from flowing through the interface box after the power outage ceases. An operator must reset the remote safety switch to allow electrical power to flow through the interface box.

The micro-controller also includes an auto-safety timer and/or programmable timer. When either timer lapses, the micro-controller provides a signal to the interface box preventing or reducing the amount of electrical power flowing through the interface box. The programmable timer could instruct the micro-controller to provide a signal to the interface box to provide increased power during peak usage periods. The micro-controller may be activated at the remote safety switch or may be activated by a detachable remote control.

### BRIEF DESCRIPTION OF THE DRAWINGS

Thus by the present invention its objects and advantages will be realized, the description of which should be taken in conjunction with the drawings wherein:

FIG. 1 is an arrangement view depicting the interface box with connections to a wall mounted electrical outlet, electrical appliance cord, and remote switch box.

FIG. 2 is an electrical schematic depicting the interface box and the remote switch box.

FIG. 3 is a front and cross-sectional view of the interface box with connections to the wall mounted electrical outlet, electrical appliance power cord, and remote switch box depicted.

FIG. 4 is a plan view of an interface box slab with aperture and an interface box U-shaped slab.

FIGS. 5 and 5A are a plan views depicting the interface box cover.

### DETAILED DESCRIPTION OF THE PREFERRED EMBODIMENTS

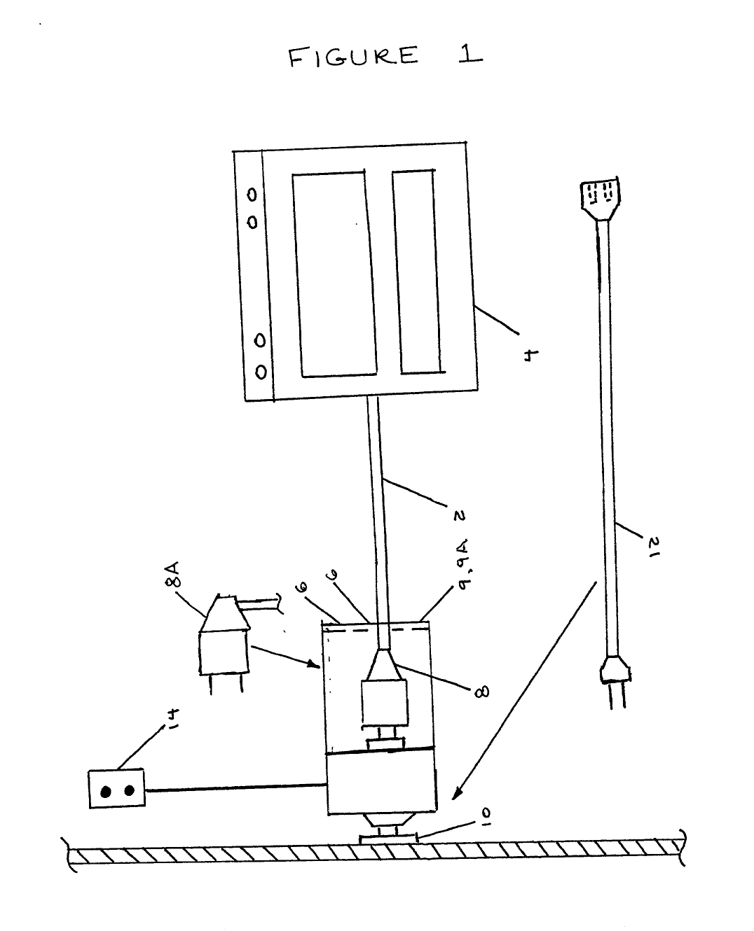

Referring now to the drawings in detail wherein like numerals refer to like elements throughout the several views, FIG. 1 depicts a power cord 2 of an electric appliance 4 inserted into the device's interface box 6.

The interface box 6 captures the plug 8 of the electrical appliance 4 so that it cannot be removed without a special tool applied to the cord plug safety lock cover 9 or by destroying the interface box 6. The interface box 6 then connects to a 120V/220V electrical wall outlet 10, either directly or by extension cord 12. Electrically connected to the interface box 6 is a low voltage locking switch, contained in remote switchbox 14.

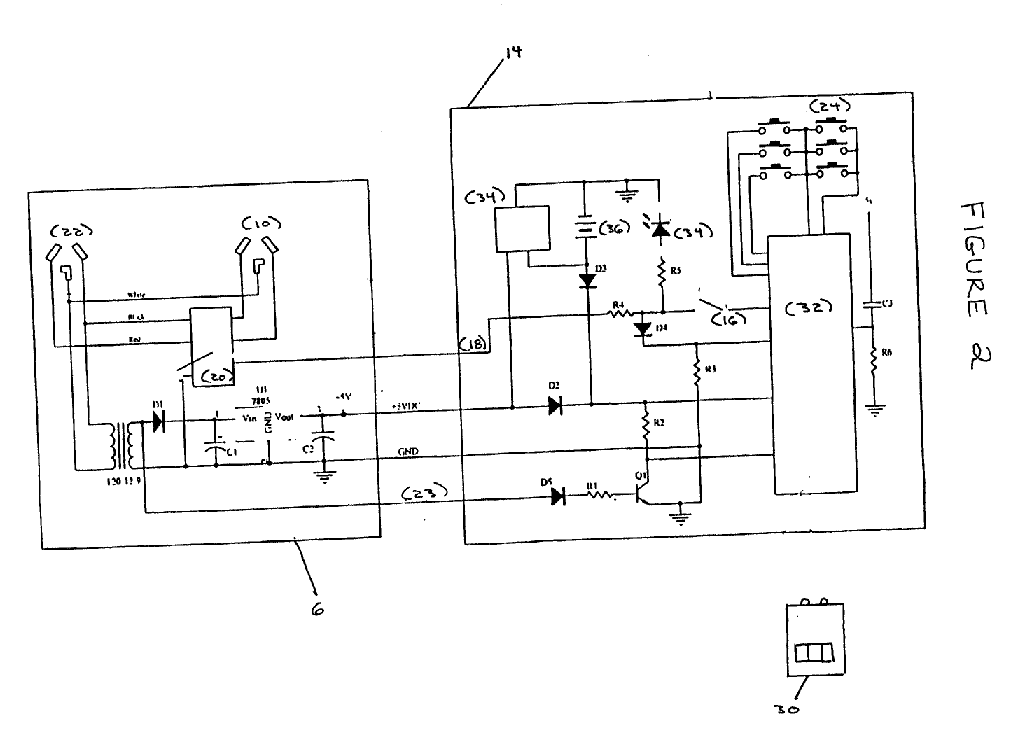

In FIG. 2, the remote switch box 14 contains a mechanical switch 16 that opens or closes the circuit by an output signal 18 to the mechanical switching circuit 20, thereby opening or closing the circuit between the appliance plug 22, a 220V plug is illustrated, and the power source at the electrical wall outlet 10, a 220V receptacle is illustrated.

The remote switch box 14 also contains a locking device 24 controlled by a key or combination keypad/switchpad with reset that can both unlock and program the device. Use of a key or a combination/switchpad would restrict use of the remote safety switch to authorized users. The locking device 24 would also control how the appliance could be used by permitting, interrupting, or regulating the flow of power between the electrical appliance plug 22 and the power source at the electrical wall outlet 10. Alternatively, a single or a collection of the locking devices 24 can be operated by a detached infrared or radio-frequency coded remote 30, as a means of activating or de-activating multiple electrical appliances.

The remote switch box 14 also contains a micro-controller 32 which determines when mechanical switch 16 will be opened or closed, depending on the settings delivered by the integral locking device 24. In a first use, the micro-controller 32 can signal to permit sufficient current for allowing timing devices such as clocks to operate, but would open mechanical switch 16 to restrict the power supply to electrical appliance 4 if the alternating current sensing line 23 detects an abnormally powerful current flow through the interface box 6. In this circumstance, the mechanical switch 16 would have to be reset at the micro-controller 32 to allow resumed power to electrical appliance 4.

The micro-controller 32 also has an integral programmable timer which permits higher electrical flows during a specific time period, usually of peak appliance use. The programmable timer can also instruct the micro-controller 32 to signal the interface box 6 to restrict power or revert to a low voltage supply to the electrical appliance after a certain amount of time elapses. This feature would be particularly important to make sure that potentially dangerous devices like space heaters, coffee makers, or an oven are not left on after a certain amount of time elapses.

An automatic timer integral with the micro-controller 32 would also instruct the micro-controller 32 to signal the interface box 6 to restrict power to the electric appliance 4 if the appliance is activated for an extended period of time. Similar to the programmable timer, this feature would be particularly important to make sure that potentially dangerous devices like space heaters, coffee makers, or an oven are not left on because the user forgot to turn them off.

The remote switch box 14 has an LED 34 which provides a visual display to authorized and unauthorized users to indicate whether or not power is being supplied from the electrical outlet 10 to the electrical appliance 4. The remote switch box 14 also contains a rechargeable backup battery 36 for maintaining the micro-controller 32 settings in the event of power failure or inadvertent disconnection from a plug. If as a result of loss of power for an extended period, the backup battery completely discharges the microprocessor 32 would continue to prevent power flow from the electrical wall outlet 10 to the appliance plug 22.

Also sensing circuit 23 can identify a power failure from the electrical wall outlet 10, either from a power outage or from a circuit breaker being thrown in the local circuit. The sensing circuit 23 would run between the interface box 6, where the power failure is detected, to the remote switch box 14. When a power failure is detected, the sensing line 23 would provide no current to the micro-controller 32 in the remote switch box 14. The micro-controller would detect the current loss and powered by rechargeable backup battery 36 would open mechanical switch 16. Once power resumes the mechanical switch 16 must be closed with the use of the micro-controller 32 to resume power by signaling the interface box 6. If the micro-controller 32 has lost programmed settings due to an extended outage mechanical switch 16 must be manually reset and closed. This function prevents an electric appliance from being re-powered after long outages.

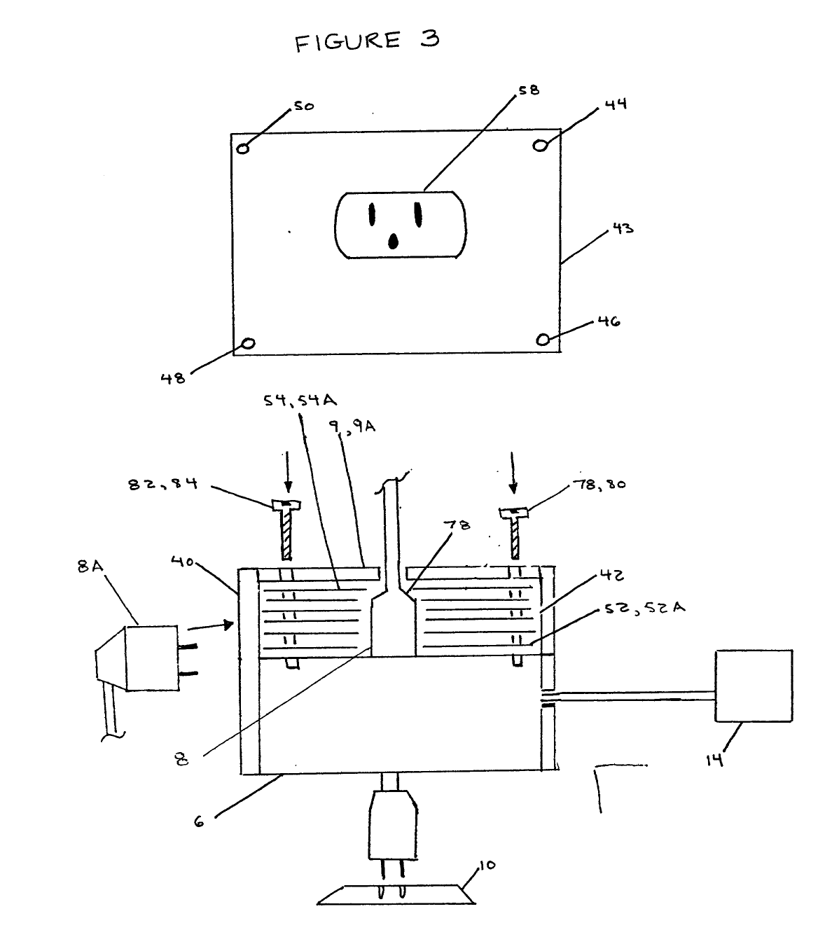

The mechanical locking device 40 in the interface box 6 is shown in FIG. 3. The locking device 40 is designed to keep an unauthorized user from unplugging the electrical appliance plug 8 from the locking device 40 and plugging it back into another electrical outlet. The locking device 40 is square with an area where the electrical appliance plug 8 is inserted. The receptacle area 42 is a cavity deeper than the length of the plug section of most power cords. At the base 43 of the cavity receptacle area 42, there are four screw receptacles 44,46,48,50.

Non conductive, non flammable packing material is inserted around the plug 8. The material that is similar to material used for insulating power cords is preferred; however, suitable substitutes may be used. Thin slabs of this material are stacked on top of each other. The slabs are provided as rigid form slabs 52 and as slightly soft sponge-like slabs 54. These sponge-like slabs 54 allow for a slightly pressurized seal between a stack of rigid slabs 52 and the cover 9, to assure a snug fit designed to minimize the chance for the plug to be disconnected once placed in the receptacle.

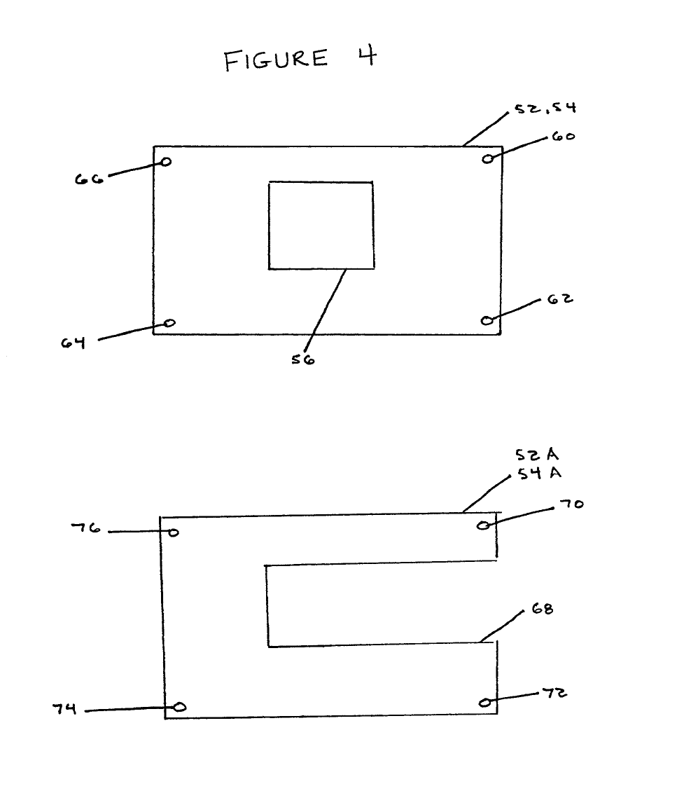

In FIG. 3, the electrical appliance plug 8 would pass through the mechanical locking device 40 to the receptacle 58. In FIG. 4 each slab 52,54 has an aperture 56 sized to accommodate the electrical appliance plug 8. The slabs 52,54 also have apertures 60,62,64,66 similar in size and location to the screw receptacles 44,46,48,50 at the base of the cavity of receptacle area 42 in FIG. 3. The electrical appliance plug 8 would pass through the mechanical locking device 40 to the receptacle 58. In FIG. 4, the slabs 52A,54A would have a notch 68 sized to accommodate a right angle type electrical appliance plug 8A. The slabs 52A,54A of FIG. 4 would also have apertures 70,72,74,76 similar in size and location to the screw receptacles 44,46,48,50 at the base of the cavity of receptacle area 42, shown in FIG. 3.

In assembly, a series of sponge-like slabs 54 are stacked around plug 8 until the slabs 54 present a surface 78 flush at the point at which plug 8 narrows significantly, generally where plug 8 meets power cord 2. A cover 9 is then placed over receptacle area 42 and screwed into the receptacle area 42 with screws 78,80,82,84 until snugly fit which immobilizes the plug 8 now contained in the receptacle area 42. Screws 78, 80, 82, 84 depending on the security preference of the user can have a variety of styles, such as standard security screws that can only be turned clockwise or screws that require an unusually shaped screwdriver. A small locking can be added for an user seeking additional security.

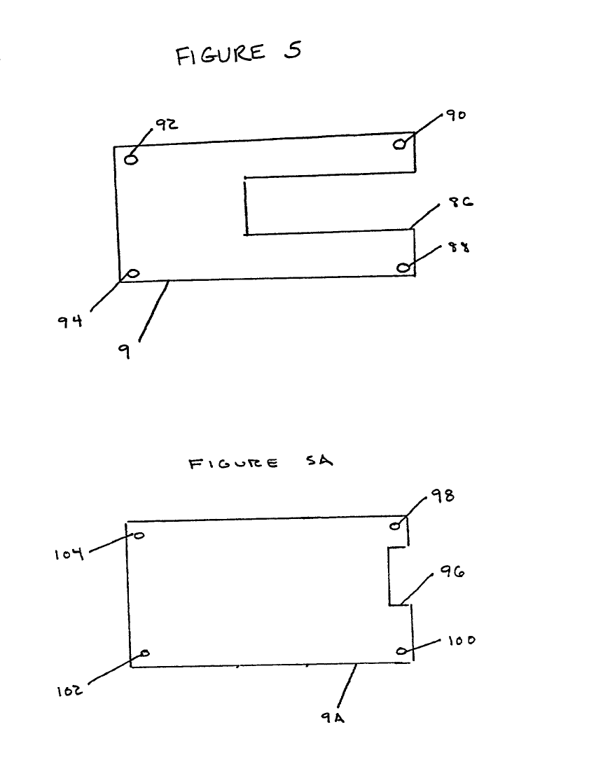

Cover 9 as shown in FIG. 5 is a rectangular section with a thickness. Cover 9 has a notch 86 sized to accommodate electrical plug 8. Cover 9 would also have apertures 88, 90, 92, 94, similar in size and location to the screw receptacles 44, 46, 48, 50 at the base of the cavity of receptacle area 42 in FIG. 3.

In FIG. 3, in an assembly for a right angle type plug 8A, a series of sponge-like slabs 54A are stacked around plug 8A until the slabs 54A present a surface 78 flush at the point at which plug 8A narrows significantly, generally where plug 8A meets power cord 2. Cover 9A would be placed over receptacle 42 when right angle type electrical plug 8A is used. Cover 9A is then placed over the receptacle area 42 and screwed into receptacle area 42 with screws 78,80,82,84 until snugly fit which immobilizes the plug 8A now contained in receptacle area 42.

Cover 9A, as shown in FIG. 5A, is a rectangular section with a thickness. Cover 9A has a notch 96 sized to accommodate right angle type plug 8A. Cover 9A would also have apertures 98,100,102,104 similar in size and location to the screw receptacles 44,46,48,50 at the base of the cavity of receptacle 42 in FIG. 3.

While the invention has been described in connection with what is considered to be the most practical and preferred embodiment, it should be understood that this invention is not limited to the disclosed embodiment, but on the contrary, is intended to cover various modifications and equivalent arrangements within the spirit and scope of the appended claims.

We claim:

1. The combination of a
a) a conventional electrical appliance having a power cord for power input
b) a control mechanism secured to be manually activated by authorized users for controlling the electrical power input from an electrical outlet to the power cord of the appliance wherein the control mechanism comprises a switch means for permitting an electrical circuit to be closed in an interface box allowing power input to the electrical appliance and for permitting an electrical circuit to be open in an interface box stopping power input to the electrical appliance; and
c) a security means whereby only authorized persons may access the control mechanism to control the power input from the electrical outlet to the electrical appliance; and
d) a sensing means wherein the sensing means detects a power failure or a power surge thereby signaling the security means to open the electrical circuit in the interface box stopping power input to the electrical appliance.

2. The invention in accordance claim 1, wherein the security means is a keylock switch having a key which is adapted to be turned in one direction to activate the control mechanism.

3. The invention in accordance with claim 2, wherein the keylock switch includes an indicator light to provide a visual display of whether or not power is being supplied from the electrical outlet to the electrical appliance.

4. The invention in accordance with claim 1, wherein the security means is a micro-controller.

5. The invention in accordance with claim 4, wherein the micro-controller includes an indicator light to provide a visual display of whether or not power is being supplied from the electrical outlet to the electrical appliance.

6. The invention in accordance with claim 4, further including a rechargeable backup battery, wherein said backup battery supplies power to the micro-controller allowing the settings of the micro-controller to be maintained during a power outage.

7. The invention in accordance with claim 6, further including a battery charger, wherein said battery charger recharges said backup battery.

8. The invention in accordance with claim 1, wherein the control mechanism is remotely located from the electrical outlet.

9. The invention in accordance with claim 1, wherein the security means must be reset upon resumption of power or reset after a power surge in order to reactivate the interface box.

10. The invention in accordance with claim 4, wherein the micro-controller further includes an automatic safety timer, wherein said automatic safety timer signals the micro-controller to deactivate the interface box after an elapsed period of time.

11. The invention in accordance with claim 4, wherein the micro-controller further includes a programmable timer, wherein said programmable timer signals the interface box to increase power during specific periods.

12. The invention in accordance with claim 11, wherein the programmable timer would automatically supply low voltage to the electrical appliance after a certain amount of time elapses.

13. The invention in accordance with claim 4, wherein the micro-controller provides low power to the interface box but deactivates the interface box when an abnormally high current is sensed.

14. The invention in accordance with claim 13, wherein the micro-controller must be reset in order to reactivate the interface box.

15. The invention in accordance with claim 4, further including a detachable remote control, wherein said remote control can activate or deactivate said micro-controller at a distance.

16. The invention in accordance with claim 1, wherein the interface box of the control mechanism further includes a mechanical safety lock cover.

17. A control mechanism secured to be manually activated by authorized users for controlling the supply of electrical power from an electrical outlet to an electrical appliance, wherein the control mechanism comprises an interface box interposed between the electrical outlet and the electrical appliance power cord for opening and closing an electrical circuit from the electrical outlet to the power cord of the electrical appliance and further comprises a security means whereby only authorized persons may access the control mechanism to control the supply of electrical power from the electrical outlet to the electrical appliance,
wherein the control mechanism further comprises a switch means for permitting the interface box to close the electrical circuit in order to supply power to the electrical appliance and for permitting the interface box to open the electrical circuit in order to cut off power supplied to the electrical appliance
wherein the control mechanism further comprises a sensing means for detecting a power failure or a power surge thereby signaling the security means to open the electrical circuit in the interface box stopping power input to the electrical appliance.

18. The invention in accordance with claim 17, wherein the security means is a keylock switch having a key which is adapted to be turned in one direction to activate the control mechanism.

19. The invention in accordance with claim 18, wherein the keylock switch includes an indicator light to provide a visual display of whether or not power is being supplied from the wall mounted electrical outlet to the electrical appliance.

20. The invention in accordance with claim 17, wherein the security means is a micro-controller.

21. The invention in accordance with claim 20, wherein the micro-controller includes an indicator light to provide a visual display of whether or not power is being supplied from the electrical outlet to the electrical appliance.

22. The invention in accordance with claim 20, further including a rechargeable backup battery wherein the backup battery supplies power to the micro-controller allowing the settings of the micro-controller to be maintained during a power outage.

23. The invention in accordance with claim 20, further including a battery charger, wherein said battery charger recharges said backup battery.

24. The invention in accordance with claim 17, wherein the control mechanism is remotely located from the electrical outlet.

25. The invention in accordance with claim 17, wherein the security means must be reset upon resumption of power or reset after a power surge in order to reactivate the interface box.

26. The invention in accordance with claim 20 wherein the micro-controller further includes an automatic safety timer, wherein said automatic safety timer signals the micro-controller to deactivate the interface box after an elapsed period of time.

27. The invention in accordance with claim 20, wherein the controllable micro-controller further includes a programmable timer, wherein said programmable timer signals the interface box to increase power during specific periods.

28. The invention in accordance with claim 27, wherein the programmable timer would automatically supply low voltage to the electrical appliance after a certain period of time elapses.

29. The invention in accordance with claim 20, wherein the micro-controller provides low power to the interface box but deactivates the interface box when an abnormally high current is sensed.

30. The invention in accordance with claim 29, wherein the micro-controller must be reset in order to reactivate the interface box.

31. The invention in accordance with claim 20, further including a detachable remote control, wherein said remote control can activate or deactivate said micro-controller at a distance.

32. The invention in accordance with claim 17, wherein the interface box of the control mechanism further includes a mechanical safety lock cover.

33. A method for controlling the power input to an electrical appliance comprising:
a) providing a control mechanism to be manually activated by a user for controlling the electrical power supply from an electrical outlet to the electrical appliance wherein the control mechanism comprises an interface box interposed between the electrical outlet and the electrical appliance; and
b) providing a security means whereby only authorized persons may access the control mechanism to control the supply of electrical power from the electrical outlet to the electrical appliance
c) wherein the control mechanism further comprises a switch means wherein the switch means permits the interface box to close the electrical circuit to supply power to the electrical appliance and for permitting the interface box to open the electrical circuit to cut off power supplied to the electrical appliance.
d) wherein the control mechanism further comprises a sensing means wherein the sensing means detects a power failure or a power surge signaling the security means to open the electrical circuit in the interface box stopping power input to the electrical appliance.

34. The invention in accordance with claim 33, wherein the security means is a keylock switch having a key which is adapted to be turned in one direction to activate the control mechanism.

35. The invention in accordance with claim 33, wherein the keylock switch includes an indicator light to provide a visual display of whether or not power is being supplied from the electrical outlet to the electrical appliance.

36. The invention in accordance with claim 33, wherein the security means is a micro-controller.

37. The invention in accordance with claim 36, wherein the micro-controller includes an indicator light to provide a visual display of whether or not power is being supplied from the electrical outlet to the electrical appliance.

38. The invention in accordance with claim 36, wherein the micro-controller includes a rechargeable backup battery, wherein said backup battery supplies power to the micro-controller allowing the settings of the micro-controller to be maintained during a power outage.

39. The invention in accordance with claim 36, wherein the micro-controller includes a battery charges, wherein said battery charger recharges said backup battery.

40. The invention in accordance with claim 33, wherein the control mechanism is remotely located from the electrical outlet.

41. The invention in accordance with claim 33, wherein the security means must be reset upon resumption of power or reset after a power surge in order to re-activate the interface box.

42. The invention in accordance with claim 36, wherein the micro-controller further includes an automatic safety timer, wherein said automatic safety timer signals the micro-controller to deactivate the interface box after an elapsed period of time.

43. The invention in accordance with claim 36, wherein the micro-controller further includes a programmable timer, wherein said programmable timer signals the interface box to increase power during specific periods.

44. The invention in accordance with claim 43, wherein the programmable timer would automatically signal the interface box to supply low voltage after a certain amount of time elapses.

45. The invention in accordance with claim 33 wherein the interface box of the control mechanism further includes mechanical safety lock cover.

46. The invention in accordance with claim 36 wherein the micro-controller supplies low power to the interface box but de-activates the interface box when an abnormally high current is sensed.

47. The invention in accordance with claim 46 wherein the micro-controller must be reset in order to return power to the interface box.

48. The invention in accordance with claim 33, further including a detachable remote control, wherein said remote control can activate a micro-controller at a distance.
